(19) United States
(12) Patent Application Publication
(10) Pub. No.: US 2010/0055334 A1
(43) Pub. Date: Mar. 4, 2010

(54) LIQUID SILICONE RUBBER COMPOSITION FOR FORMING BREATHABLE COATING FILM ON A TEXTILE AND PROCESS FOR FORMING A BREATHABLE COATING FILM ON A TEXTILE

(75) Inventor: Su-Hong Kim, Daejeon (KR)

Correspondence Address: SEED INTELLECTUAL PROPERTY LAW GROUP PLLC, 701 FIFTH AVE, SUITE 5400, SEATTLE, WA, 98104, US

(73) Assignee: DOW CORNING KOREA LTD., Seoul (KR)

(21) Appl. No.: 12/298,270

(22) PCT Filed: Apr. 26, 2007
(86) PCT No.: PCT/KR2007/002037

§ 371 Date: Mar. 5, 2009

(30) Foreign Application Priority Data
Apr. 26, 2006 (KR) 10-2006-0037671

(51) Int. Cl. B05D 3/02; C09D 183/04; B05D 7/00

(52) U.S. Cl. 427/387; 524/500

(57) ABSTRACT

This invention relates to a liquid silicone rubber (LSR) composition useful for forming a breathable coating film on a textile, in particular, woven, non-woven or knitted fabric and synthetic leather, and a process for producing a breathable coating film on a textile. This coating film is characterized by showing moisture permeation and water proofness.

### TECHNICAL FIELD

This invention relates to a liquid silicone rubber (LSR) composition useful for forming a breathable coating film on a textile, in particular, woven, non-woven or knitted fabric and synthetic leather for clothing, and a process for forming a breathable coating film on a textile. The word “breathable coating film” intends to mean a coating film which does permeate moisture (water) vapor, but does not allow water droplet to permeate.

### BACKGROUND ART

Liquid silicone rubber (“LSR”) is well known in silicone industry, which is available in form of liquid and cures to form a silicone elastomer. LSR has been attractively used in fabric application due to the soft hand feel and washing durability. Therefore the LSR coated textile such as woven, non-woven or knitted fabric and synthetic leather was useful for garment clothing, shoes, upholstery of furniture such as seat, chair, sofa, etc. and the like.

The LSR coating has gas permeability and water repellency as property inherent in silicone elastomer per se. However as moisture vapor permeability of the LSR coating was still worse, it was advantage of the LSR coated cloth that it could shed rain water, but the LSR coated clothing did not allow water vapor of sweating to escape enough. Therefore it was not sufficiently satisfactory in the clothing market.

This invention was accomplished by preparing a LSR coating composition comprising (A) a liquid polydiorganosiloxane containing at least two alkenyl radicals in each molecule, (B) an organohydrogenpolysiloxane containing at least three silicon-bonded hydrogen atoms in each molecule, (C) a thermo-expandable microcapsule and (D) a hydrosilation catalyst, and optionally (E) a reinforcing filler, coating the LSR coating composition onto a textile such as fabrics and synthetic leather, and curing/foaming the LSR coating composition on the textile.

In U.S. Pat. No. 5,246,973 LSR composition containing a thermally expandable hollow plastic microparticle is disclosed to provide a silicone rubber foamed product, which can be foamed without any problem such as toxicity and/or order of by-produced decomposition gas, and which is light and shows excellent heat resistance and weather resistance to be used in wide applications such as automobile parts, seal, packing, gasket, O-ring, and the like as well as the conventional silicone rubber foam. This US patent does not suggest use of the foamable composition in the textile application.

U.S. Pat. No. 6,420,037 discloses LSR coating composition for air bag. This composition containing a spherical powder such as hollow aluminosilicate powder, glass sphere, silica sphere, hollow plastic sphere and the like to reduce surface tackiness of the air bag's coating film, was applied to fabric of air bag, where gas filled in the air bag must not be leaked. However this US patent does not teach use of the LSR composition in fabric application where higher water vapor permeability is required.

### SUMMARY OF THE INVENTION

This invention relates to a liquid silicone rubber (LSR) composition useful for forming a breathable coating film on a textile, in particular, woven, non-woven or knitted fabric and synthetic leather, and a process for producing a breathable coating film on a textile. This coating film is characterized by showing moisture permeation and waterproofness.

### DETAILED DESCRIPTION OF THE INVENTION

This invention provides a liquid silicone rubber (LSR) composition useful for breathable coating film on a textile, in particular, woven, non-woven or knitted fabric and synthetic leather, comprising:

(A) 100 parts by weight of a liquid polydiorganosiloxane containing at least two alkenyl radicals in each molecule,

(B) an organohydrogenpolysiloxane containing at least three silicon-bonded hydrogen atoms in each molecule, in an amount that the molar ratio of the total number of the silicon-bonded hydrogen atoms in this ingredient to the total quantity of all alkenyl radicals in the ingredient (A) is from 0.5:1 to 20:1,

(C) from 0.1 to 10 parts by weight per 100 parts by weight of the sum of ingredients (A), (B), (D) and (E) of a thermo-expandable microcapsule,

(D) a hydrosilation catalyst, and optionally

(E) from 0 to 50 parts by weight of a reinforcing filler, based on the amount of the ingredient (A).

This invention also provides a process for producing a breathable coating film on a textile, in particular, woven, non-woven or knitted fabric and synthetic leather by comprising (I) preparation of the liquid silicone rubber composition above-mentioned, (II) coating said composition onto a textile, and (III) causing to cure & foam the liquid silicone composition on the textile.

This invention also provides production of breathable coating film on a textile, in particular, woven, non-woven or knitted fabric and synthetic leather, by preparing a LSR coating composition above-mentioned, applying the LSR coating composition to the textile and heating to concurrently cure and foam the LSR coating composition on the substrate at the temperature sufficient to cause expansion of the ingredient (C) and curing the LSR coating composition.

The ingredients that may be comprised in the LSR composition of the present invention are discussed below:

(A) Liquid Alkenyl-Containing Polydiorganosiloxane

Ingredient (A) is a liquid polydiorganosiloxane containing at least two silicon-bonded alkenyl radicals in each molecule. Suitable alkenyl radical of the ingredient (A) contains from 2 to 10 carbon atoms and the preferred species thereof are, for example, vinyl, allyl, and 5-hexenyl. The ingredient (A) may have silicon-bonded organic groups other than alkenyl radical. Such silicon-bonded organic groups are typically selected from monovalent saturated hydrocarbon radicals, which preferably contain from 1 to 10 carbon atoms, and monovalent aromatic hydrocarbon radicals, which preferably contain from 6 to 12 carbon atoms, which are unsubstituted or substituted with the groups that do not interfere with curing of this inventive composition, such as halogen atoms. Preferred species of the silicon-bonded organic groups are, for example, alkyl such as methyl, ethyl, and propyl; halogenated alkyl such as 3,3,3-trifluoropropyl; and aryl such as phenyl.

The molecular structure of the ingredient (A) is typically linear, however, there can be some branching due to the presence of trivalent siloxane units within the molecule. To achieve a useful level of physical properties in the elastomer prepared by curing the LSR composition of the present invention, the molecular weight of the ingredient (A) should be sufficient so that it achieves a viscosity of at least 0.1 Pa·s at 25° C. The upper limit for the molecular weight of the ingredient (A) is not specifically restricted and is typically limited only by the processability of the LSR composition of the present invention.

Preferred embodiments of the ingredient (A) are polydiorganosiloxanes containing alkenyl radicals at the two terminals and are represented by the general formula I:

R′R″R″′SiO-(R″R′″SiO)ₘ-SiOR″′R″R′I.

In formula I, each R′ is an alkenyl radical, which preferably contains from 2 to 10 carbon atoms, such as vinyl, allyl, and 5-hexenyl.

R″ does not contain ethylenic unsaturation, and is identical or different and individually selected from monovalent saturated hydrocarbon radical, which preferably contain from 1 to 10 carbon atoms, and monovalent aromatic hydrocarbon radical, which preferably contain from 6 to 12 carbon atoms. R″ may be unsubstituted or substituted with the group that does not interfere with curing of this inventive composition, such as halogen atoms. R″′ is R′ or R″. m represents a degree of polymerization equivalent to that the ingredient (A) has a viscosity of at least 0.1 Pa·s at 25° C., preferably from 0.1 to 300 Pa·s.

Preferably, all of the R″ and R″′ of formula I are methyl. Alternative preference is that at least one of the R″ and R″′ or most of the R″ and R″′ of formula I is methyl and the remaining is phenyl or 3,3,3-trifluoropropyl. This preference is based on the availability of the reactants typically used to prepare the polydiorganosiloxanes (the ingredient (A)) and the desired properties for the cured elastomer prepared from compositions comprising such polydiorganosiloxanes.

Representative embodiments of the ingredient (A) containing ethylenically unsaturated hydrocarbon radicals only at the terminals includes, but are not limited to, dimethylvinylsiloxy-terminated polydimethylsiloxane, dimethylvinylsiloxy-terminated polymethyl-3,3,3-trifluoropropylslioxane, dimethylvinylsiloxy-terminated dimethylsiloxane-3,3,3-trifluoropropylmethylsiloxne copolymer, and dimethylvinylsiloxy-terminated dimethylsiloxane/methylphenylsiloxane copolymer.

Generally, the ingredient (A) has a viscosity of at least 0.1 Pa·s at 25° C., preferably from 0.1 to 300 Pa·s.

(B) Organohydrogenpolysiloxane

Ingredient (B) is an organohydrogenpolysiloxane, which operates as a cross-linker for curing the ingredient (A), by the addition reaction of the silicon-bonded hydrogen atoms in this ingredient with the alkenyl groups in the ingredient (A) under catalytic activity of the ingredient (D) to be mentioned below. The ingredient (B) normally contains 3 or more silicon-bonded hydrogen atoms so that the hydrogen atoms of this ingredient can sufficiently react with the alkenyl radicals of the ingredient (A) to form a network structure, in order to satisfactorily curing the ingredient (A). As this reaction causes to cure the LSR composition, it is easily understood that the ingredient (B) having two silicon-bonded hydrogen atoms functions as a crosslinker still, when the ingredient (A) has 3 or more alkenyl radicals.

The molecular configuration of the ingredient (B) is not specifically restricted, and it can be straight chain, branch-containing straight chain, or cyclic. While the molecular weight of this ingredient is not specifically restricted, the viscosity is preferably from 0.001 to 50 Pa·s at 25° C. in order to obtain a good miscibility with the ingredient (A).

The ingredient (B) is preferably added in an amount that the molar ratio of the total number of the silicon-bonded hydrogen atoms in this ingredient to the total quantity of all alkenyl radicals in the ingredient (A) is from 0.5:1 to 20:1, with 1:1 to 10:1 being preferred. When this ratio is less than 0.5:1, a well-cured composition will not be obtained. When the ratio exceeds 20:1, there is a tendency for the hardness of the cured composition to increase when heated.

Examples of the ingredient (B) include but are not limited to:

(i) trimethylsiloxy-terminated methylhydrogenpolysiloxane,

(ii) trimethylsiloxy-terminated polydimethylsiloxane-methylhydrogensiloxane,

(iii) dimethylhydrogensiloxy-terminated dimethylsiloxane-methylhydrogensiloxane copolymers,

(iv) dimethylsiloxane-methylhydrogensiloxane cyclic copolymers,

(v) copolymers composed of (CH₃)₂HSiO_{1/2} units and SiO_{4/2} units, and

(vi) copolymers composed of (CH₃)₃SiO_{1/2} units, (CH₃)₂HSiO_{1/2} units, and SiO_{4/2} units.

(C) Thermo-Expandable Microcapsule

Ingredient (C) is a thermo-expandable microcapsule that comprises a volatile substance enclosed in spherical shells composed of a thermoplastic resin and expands when heated. Example of the thermoplastic resin that forms the shell of this ingredient includes polyethylene, polystyrene, polyvinyl acetate, polyvinyl chloride, polyvinylidene chloride, polyacrylonitrile, polymethyl methacrylate, polybutadiene, polychloroprene, and other vinyl polymers and copolymers thereof; Nylon 6, Nylon 66, and other polyamides; and polyethylene terephthalate, polyacetal, and blends thereof. Example of the volatile substance enclosed in the thermo-expandable microcapsule includes butane, isobutene, propane, and other hydrocarbons; methanol, ethanol, and other alcohols; dichloroethane, tirchloroethane, trichloroethylene, and other halogenated hydrocarbons; and diethyl ether, isopropyl ether, and other ethers. It is preferable that the particle diameter of the ingredient (C) is in the ranges of 5 to 50 microns with most preferable range of 5.0 to 15 microns prior to expansion and 5 to 200 microns with most preferable range of 5.0 to 50.0 microns after expansion. Good water vapor permeability is not obtained if the particle diameter is less than 5 micron, and if it exceeds 50 microns, the strength of the thermoplastic resin hollow-particle powder weakens to the extent that the particles will break up during formulating the liquid silicone rubber base composition. The amount in which ingredient (C) is compounded is usually 0.1 to 10 parts by weight per 100 parts by weight of the sum of ingredients (A), (B), (D) and (E) in the present composition. Good water vapor permeability is not obtained if the amount is less than 0.1 parts by weight, but if the amount is larger than 10 parts by weight, the viscosity of the liquid silicone rubber base composition will be too high to process the liquid silicone rubber base composition and/or the surface of cured coating film show worse appearance. It is preferable that the amount of ingredient (C) is in the range of 0.1 to 5 parts by weight per 100 parts by weight of the sum of the ingredients (A), (B), (D) and (E), with most preferable range of 0.5 to 1.5 parts by weight.

(D) Hydrosilation Catalyst

Curing of the LSR composition of this invention is preformed by ingredient (D), which is a hydrosilation catalyst that is a metal selected from the platinum group of the periodic table, or a compound of such metal. The metals include platinum, palladium, and rhodium. Platinum and platinum compounds are preferred due to the high activity level of these catalysts in hydrosilation reaction.

Example of preferred curing catalysts include but are not limited to platinum black, platinum on various solid supports, chloroplatinic acids, alcohol solutions of chloroplatinic acid, and complexes of chloroplatinic acid with liquid ethylenically unsaturated compounds such as olefins and organosiloxanes containing ethylenically unsaturated silicon-bonded hydrocarbon radicals. Complexes of chloroplatinic acid with organosiloxanes containing ethylenically unsaturated hydrocarbon radicals are described in U.S. Pat. No. 3,419,593.

The concentration of the ingredient (D) in the LSR composition of this invention is equivalent to a platinum-group metal concentration from 0.1 to 500 parts by weight of platinum-group metal, per million parts (ppm), based on the combined weight of the ingredients (A) and (B).

Mixtures of the aforementioned ingredients (A), (B), and (D) may begin to cure at ambient temperature.

To obtain a longer working time or pot life of the LSR composition of this invention, a suitable inhibitor can be used in order to retard or suppress the activity of the catalyst. For example, the alkenyl-substituted siloxanes as described in U.S. Pat. No. 3,989,887 may be used. Cyclic methylvinylsiloxanes are preferred.

Another class of known inhibitors of platinum catalysts includes the acetylenic compounds disclosed in U.S. Pat. No. 3,445,420. Acetylenic alcohols such as 2-methyl-3-butyl-2-ol constitute a preferred class of inhibitors that will suppress the activity of a platinum-containing catalyst at 25° C. Compositions containing these inhibitors typically require heating at temperature of 70° C. or above to cure at a practical rate.

Inhibitor concentrations as low as 1 mole of inhibitor per mole of the metal will in same instances impart satisfactory storage stability and cure rate. In other instances inhibitor concentrations of up to 500 moles of inhibitor per mole of the metal are required. The optimum concentration for a given inhibitor in a given composition is readily determined by routine experimentation.

(E) Reinforcing Filler

To achieve high level of physical properties that characterize some types of cured elastomer that can be prepared using the LSR composition of this invention, it may be desirable to optionally include a reinforcing filler such as finely divided silica. Silica and other reinforcing fillers are often treated with one or more known filler treating agents to prevent a phenomenon referred to as “creping” or “crepe hardening” during processing of the curable composition.

Finely divided forms of silica are preferred reinforcing fillers. Colloidal silicas are particularly preferred because of their relatively high surface area, which is typically at least 50 square meters per gram. Fillers having surface areas of at least 200 square meters per gram are preferred for use in the present invention. Colloidal silicas can be of precipitated type or a fume type. Both types of silica are commercially available.

The amount of finely divided silica or other reinforcing filler used in the LSR composition of this invention is at least in part determined by the physical properties desired in the cured elastomer. The LSR composition of this invention typically comprises from 0 to 50 parts by weight of a reinforcing filler (e.g., silica), per 100 parts by weight of the polydiorganosiloxane (the ingredient (A)). The amount of silica or other fillers should not exceed the amount that increases the viscosity of the LSR composition of the present invention above 300 Pa·s.

The filler treating agent can be any of low molecular weight organosilicon compounds disclosed in the art applicable to prevent creping of polydiorganosiloxane compositions during processing.

The treating agents exemplify but not limited to liquid hydroxyl-terminated polydiorganosiloxane containing an average from 2 to 20 repeating units of diorganosiloxane in each molecule, hexaorganodisiloxane, hexaorganodisilazane, and the like. The hexaorganodisilazane intends to hydrolyze under conditions used to treat the filler to form the organosilicon compounds with hydroxyl groups. Preferably, at least a portion of the silicon-bonded hydrocarbon radicals present in the treating agent are identical to a majority of the hydrocarbon radicals present in the ingredients (A) and (B). A small amount of water can be added together with the silica treating agent(s) as processing aid.

It is believed that the treating agents function by reacting with silicon-bonded hydroxyl groups present on the surface of the silica or other filler particles to reduce interaction between these particles.

The filler may be surface-treated with the treating agent prior to formulating, and the treated filler is commercially available.

When untreated silica is used as filler, it is preferably treated with a treating agent in the presence of at least a portion of the other ingredients of the LSR composition of the present invention by blending these ingredients together until the filler is completely treated and uniformly dispersed to for a homogeneous material. Preferably, the untreated silica is treated with a treating agent in the presence of the ingredient (A).

Furthermore the LSR composition of this invention may contain various optional ingredients that are conventionally utilized in such compositions, such as pigments and/or dyes. Any pigments and dyes, which are applicable to silicone elastomers or coating but do not inhibit the hydrosilation curing reaction type addition reaction, can be employed in this invention. The pigments and dyes include but are not limited to carbon black, titanium dioxide, chromium oxide, bismuth vanadium oxide and the like. In a preferred embodiment of the invention, the pigments and dyes are used in form of pigment master batch composed of them dispersed in the polydiorganosiloxane with a low viscosity (the ingredient (A)) at the ratio of 25:75 to 70:30.

The other optional ingredients comprise, for example, non-reinforcing fillers, such as diatomaceous earth, quarts powder, alumina and calcium carbonate; flame-retardants; and heat and/or ultraviolet light stabilizers.

### Preparations

The LSR composition of this invention can be easily produced by adding and uniformly mixing all of the ingredients at ambient temperature. Any mixing techniques and devices described in the prior art can be used for this purpose. The particular device to be used will be determined by the viscosities of the ingredients and the final curable coating composition. Suitable mixers include but are not limited to paddle type mixers, kneader type mixers and kneader extruder. Cooling of the ingredients during mixing may be desirable to avoid premature curing of the composition.

The order for mixing the ingredients is not critical in this invention. Preferably, it is desirable to prepare the LSR composition of this invention in two parts at first, one part comprising the ingredient (A), the ingredient (D) and the ingredient (E), and the other part comprising the ingredient (B), the ingredient (E) and if necessary, the inhibitor for the hydrosilation catalyst, and where the ingredient (C) may be added to either of the parts. Then the two parts are mixed at room temperature to form the LSR composition of this invention.

The viscosity of the LSR composition is not critical, either. For screen coating the viscosity is in the range of from 20 Pa·s to 150 Pa·s at 25° C. The composition with a viscosity of 3 Pa·s is still acceptable to gravure coating and the composition with a viscosity of 200 Pa·s. may be coatable by knife coating.

The LSR composition of this invention can be coated onto a textile such as woven, non-woven or knitted fabric (e.g. cotton, polyester, nylon, etc.) and synthetic leather by conventional applying mean such as knife coating, dip coating, gravure coating, screen coating, lamination and the like. The thick film with 50 up to 300 microns is obtained by the laminating process, and the knife coating provides thickness of from 1 to 100 microns.

The coating film is heated at the temperature of from 110 degree C. to 180 degrees C. for period of 10 seconds to 5.0 minutes. This heating causes to cure and foam the LSR coating composition to form open cell.

### Examples

The coating composition of this invention was prepared in form of two Part A and Part B as follows:

As Part A, Vi-Siloxane 1, Fumed Silica, Silazane, Silazane 2 and water were mixed in a high shear mixer (like Turello) for 1.0-2.0 hours, and striped at 180 degrees C. under vacuum to form homogenous mixture. The mixture was cooled down to the room temperature. Thermo-expandable microcapsule was admixed with the mixture, followed by addition of Platinum Catalyst. The mixture was filtered to obtain Part A composition.

Part B was prepared by mixing Vi-Siloxane 1, Vi-Siloxane 2, Fumed Silica, Silazane and water in a high shear mixer (like Turello) for 1.0-2.0 hours, and stripping at 180 degrees C. under vacuum, and then cooling down to the room temperature to form homogenous mixture. H-Siloxane and Inhibitor were admixed with the above homogenous mixture, and the mixture was filtered to obtain Part B composition.

The amounts of those ingredients are shown in Table below. The thermo-expandable microcapsules, of which forms are shown in Table 2, were added in amount of 0.5 parts by weight per 100 parts by weight of the sum of 50 parts by weight of Part A (not including the Thermo-expandable microcapsule) and 50 parts by weight of Part B compositions to produce the coating compositions of this invention.

TABLE 1

| | | Part A | Part B |
|---|---|---|---|
| Vi-Siloxane 1 | Vinyl-terminated polydimethylsiloxane | 67.3 | 54.3 |
| | having the viscosity of 55 Pa · s at | | |
| | 25 degree C. | | |
| Vi-Siloxane 2 | dimethylvinylsiloxy-terminated polydimethyl- | 6.6 | 6.2 |
| | methylvinylsiloxane having 1.2 mole % of | | |
| | vinyl radical and the viscosity of 0.35 | | |
| | Pa · s at 25 degree C. | | |
| H-Siloxane | Trimethylsiloxy-terminated polydimethyl- | | 11.0 |
| | methylhydrogensiloxane having 0.12% by | | |
| | weight of hydrogen atom bonded to silicon | | |
| | and the viscosity of 0.005 Pa · s at | | |
| | 25 degree C. | | |
| Fumed Silica | Fumed silica having the surface area of | 20.0 | 21.2 |
| | 160 m²/g | | |
| Silazane | Hexamethyldisilazane | 4.1 | 4.1 |
| Platinum | Is obtained by preparing a platinum complex | 2.0 | |
| Catalyst | solution composed of 2.3 wt. % of | | |
| | vinylsiloxane- platinum complex prepared | | |
| | from platinum dichloride and | | |
| | 1,3-divinyl-1,1,3,3-tetramethyldisiloxane | | |
| | according to method described in USP | | |
| | 5175325; 91.9 wt. % of vinyldimethylsiloxy- | | |
| | terminated polydimethylsiloxane having the | | |
| | viscosity of 0.45 Pa · s at 25 degrees C.; | | |
| | and 5.8 wt. % by weight of | | |
| | 1,3-divinyl-1,1,3,3-tetramethyldisiloxane, and | | |
| | then diluting 15 wt. % of the plantinum | | |
| | complex solution with 85 wt. % of Vi-Siloxane 2. | | |
| | This catalyst composition contains | | |
| | platinum in amount of 780 ppm. | | |
| Inhibitor | 97 wt. % of Vi-Siloxane 2 and 3 wt. % of | | 3.2 |
| | 1-Ethynyl-1-cyclohexanol | | |
| Water | Water | 0.8 | 0.8 |
| Total | | 100.8 | 100.8 |

TABLE 2

| | Thermo- | Thermo- | Thermo- |
|---|---|---|---|
| | Expandable | Expandable | Expandable |
| | Microcapsule | Microcapsule | Microcapsule |
| | 1 | 2 | 3 |
| Shell material | Acrylonitrile | Acrylonitrile | Acrylonitrile |
| | Copolymer | Copolymer | Copolymer |
| Blowing agent | Iso-Pentane | Iso-Pentane | Iso-Pentane |
| Maximum expansion | 30 | 10 | 80 |
| ratio, by volume | | | |
| (times) | | | |
| Particle size (micron) | 5~8 | 25~45 | 25~35 |
| Blowing temperature, | 145~150 | 130~140 | 100~110 |
| start (° c.) | | | |

Then the Part A and Part B compositions were mixed and coated onto polyester fabric. Prior to the coating, the polyester fabric was pre-heated at 110 degrees C. for 10 seconds, and laminated onto an uncured coating film of the coating composition coated on a plastic sheet, and was heated at 150 degrees C. for 2 minutes to cure and foam the coating composition. The coating film on the polyester fabric had thickness such that the coating weight (grams per square meter) was shown in Table 3.

The coated polyester fabric was tested to show the results in Table 3.

TABLE 3

| | | Exam- | Exam- | Exam- |
|---|---|---|---|---|
| | Comparative | ple 1 | ple 2 | ple 3 |
| Formulation | | | | |
| LSR Base* | 100 | 100 | 100 | 100 |
| Thermo-Expandable | — | 0.5 | — | — |
| Microcapsule 1 | | | | |
| Thermo-Expandable | — | — | 0.5 | — |
| Microcapsule 2 | | | | |
| Thermo-Expandable | — | — | — | 0.5 |
| Microcapsule 3 | | | | |
| Result | | | | |
| Appearance | Good | Good ** | big cell | big cell |
| Coating Weight(gsm) | 71.0 | 70.5 | 71.5 | 71.7 |
| Cell Size, Ave. | 0 | 45 | 100 | 130 |
| (micron) | | | | |
| Water Vapor Per- | 300 | 2,000 | 3,100 | 5,000 |
| meability (ASTM E96 | | | | |
| BW)(gm/24 hrs) | | | | |
| Water Proofing(ISO | >10,000 | >10,000 | >10,000 | >10,000 |
| 811)(mmbar) | | | | |

LSR Base was one composed of Part A and Part B, where 100 parts by weight did not contain an amount of the Thermo-expandable Microcapsule.
Unit of those quantities was parts by weight.
** Good Appearance means “Invisible Cell”.

The above LSR Base was mixed with various amounts of Thermo-Expandable Mirocapsule 1 above-mentioned to produce coating compositions. The coating compositions were coated onto Nylon 6 fabric by knife coating, and cured at the temperature of 150 degrees C. for 2.0 minutes. The coating film thickness were shown as coating weight in Table 4 below.

The coated Nylon 6 fabrics were evaluated by the same tests as above, and the test results are shown in Table 4

TABLE 4

| | Comparative | Exam- | Exam- | Exam- |
|---|---|---|---|---|
| | 2 | ple 4 | ple 5 | ple 6 |
| Formulation LSR | 1000 | 1000.5 | 1001.0 | 1001.5 |
| BaseThermo-Expandable | | | | |
| Microcapsule 1 | | | | |
| Coating Weight (gsm) | 30 | 28 | 17 | 12 |
| Water Proofing(mmbar) | 2800 | 400 | 520 | 300 |
| Water Vapor Per- | 678 | 848 | 3138 | 5258 |
| meability(gm/24 hr/m²) | | | | |

1. A liquid silicone rubber (LSR) composition useful for forming a breathable coating film on a textile comprising:
(A) 100 parts by weight of a liquid polydiorganosiloxane containing at least two alkenyl radicals in each molecule,
(B) an organohydrogenpolysiloxane containing at least three silicon-bonded hydrogen atoms in each molecule, in an amount that the molar ratio of the total number of the silicon-bonded hydrogen atoms in this ingredient to the total quantity of all alkenyl radicals in the ingredient (A) is from 0.5:1 to 20:1,
(C) from 0.1 to 10 parts by weight per 100 parts by weight of the sum of ingredients (A), (B), (D) and (E), of a thermo-expandable microcapsule,
(D) a hydrosilation catalyst, and
(E) from 0 to 50 parts by weight of a reinforcing filler, based on the amount of the ingredient (A).

2. The liquid silicone rubber composition according to claim 1, wherein the textile is woven, non-woven or knitted fabric, or synthetic leather.

3. A method for forming a breathable coating film on a textile which comprises preparing of the coating composition of claim 1, and applying the coating composition to a textile and heating to cure and foam the coating at the temperature sufficient to cause curing and expansion of ingredient (C) to form cell.

4. A method for forming a breathable coating film on a textile according to claim 3 wherein the textile is woven, non-woven or knitted fabric, or synthetic leather.
